(19) United States
(12) Patent Application Publication
(10) Pub. No.: US 2005/0279026 A1
(43) Pub. Date: Dec. 22, 2005

(54) Weatherstrip for vehicles

(75) Inventors: Hideshi Tsuchida, Hiroshima (JP); Tsuyoshi Noda, Tokyo (JP)

Correspondence Address: FRISHAUF, HOLTZ, GOODMAN & CHICK, PC, 220 5TH AVE FL 16, NEW YORK, NY, 10001-7708, US

(73) Assignees: Nishikawa Rubber Co., Ltd., Hiroshima (JP); Mitsubishi Jidosha Kogyo Kabushikikaisha, Tokyo (JP)

(21) Appl. No.: 11/122,505

(22) Filed: May 4, 2005

(30) Foreign Application Priority Data
Jun. 17, 2004 (JP) 2004-179717

(51) Int. Cl. B60J 1/16

(52) U.S. Cl. 49/495.1

(57) ABSTRACT

A weatherstrip for vehicles comprising extruded parts and molded part, wherein the extruded parts are attached to the header and front pillar of a convertible car and the molded part is attached to the corner, the hollow sealing section of the molded part has a pad therein for an improved reaction force and is provided with a rib for positioning the pad at a required point to prevent the pad from dislocating when the door is closed and the side glass is pressed against it, and the rib also serves to improve the rigidity of the sealing section at the required position and, accordingly, increase the sealing pressure.

### CROSS-REFERENCE TO THE RELATED ART

This application incorporates by reference the subject matter of Application No. 2004-179717, filed in Japan on Jun. 17, 2004, on which a priority claim is based under 35 U.S.C. §199(a).

### BACKGROUND OF THE INVENTION

1. Field of the Invention

The present invention relates to a weatherstrip for vehicles consisting of extruded parts and a molded part connected to the extruded parts, and relates in particular to a weatherstrip having a pad for improved reaction force in a hollow sealing section formed in the molded part.

2. Description of the Related Art

FIG. 4 shows an application of the weatherstrip in a convertible car in which the extruded parts 1 are attached to the header and front pillar and the molded part 2 is attached to the corner to connect the extruded parts 1. FIG. 5 is an enlarged view of part a in FIG. 4. FIGS. 6 and 7 are cross-sections at the lines 6-6 and line 7-7, respectively, in FIG. 5. The molded part 2 shown in FIGS. 6 and 7 consists of a mounting base 5 fitted in a retainer 4 mounted onto the front pillar 3 and a hollow sealing section 7 that abuts and seals the side glass 6 when the door 10 is closed. A sponge rubber pad 8 is provided inside the sealing section 7. The pad 8 is provided for the following reasons.

The weatherstrip described above serves not only to seal the side glass 6 when the door 10 is closed, but also to seal the front edge of the roof when the roof 9 is closed. It is desirable to tightly press the weatherstrip against the side glass 6 and the roof front edge to increase sealing pressure for high sealing performance.

In order to increase the sealing pressure, the weatherstrip has to be improved in rigidity so as to increase the reaction force.

To do so, the extruded part often is provided with a bridge at the hollow sealing section.

However, the molded part has to have some cores to form a hollow sealing section with a contained bridge. Accordingly, the number of steps for removing cores after molding is needed. Therefore, the molded part generally is provided with a pad 8 in a hollow sealing section, as shown in FIGS. 6 and 7. In the figure, the number 11 indicates an interior member and the number 12 indicates a mole.

The triangles in FIG. 7 indicate that the extruded part 1 is on the outlined side and the molded part 2 is on the filled side.

Japanese Laid Open Utility Model Application No. H05-62314 discloses an extruded weatherstrip having a projection for holding a pad inserted in the hollow sealing section.

If the sealing section 7 has a relatively large hollow area compared to the pad 8, such as that shown in the molded part 2 of FIGS. 6 and 7, the pad 8 easily moves around in the sealing section 7. When the door 10 is closed and the side glass 6 hits it, the pad 8 shifts in the direction of the arrows, in which case the pad 8 fails to increase the reaction force of the sealing section 7. This problem occurs not only on the weatherstrip of convertible cars but also on the weatherstrip of hard-top cars and other types of vehicles in which a pad is provided in the molded part and dislocated when the door is closed.

In order to resolve this problem, attempts have been made to mold a pad itself into a special shape to immobilize it or to use a material having a small specific gravity to form a pad, such as a urethane pad, so that the pad easily fits in the inner contour of the molded part. The former technique successfully yields excellent sealing performance. However, extra cost is required to mold a pad into a special shape. The latter technique may impair the shape of the weatherstrip when the entire hollow sealing section of the molded part is filled or when a larger or harder pad is used in order to increase the sealing reaction force. Therefore, it fails to significantly increase the sealing reaction force.

The method disclosed in the Japanese Laid Open Utility Model Application No. H05-62314 described above prevents the pad from moving around with the help of the projection biting into it.

The molded part attached to the corner generally has a large cross-section in the hollow sealing section. Therefore, the technique used for extruded objects as disclosed in the prior art above cannot be applicable as it is.

The purpose of the present invention is to provide a weatherstrip for vehicles in which the pad is positioned at a pre-determined point, whereby the hollow sealing section is partially improved in rigidity only at a required point and an increase in the reaction force is minimized when a door or the like, is closed, increasing the sealing performance.

### SUMMARY OF THE INVENTION

The weatherstrip of the present invention consists of extruded parts and a molded part connected to the extruded parts. The molded part has a hollow sealing section for elastically abutting and sealing, in addition to the above described side glass of a convertible car, the door and side glass of a hard-top car and a closure, such as the door and a trunk of a general vehicle. The sealing section is provided with a pad in a part of the hollow cross-section to improve the reaction force thereof, and with a positioning means to position the pad at a predetermined position.

### BRIEF DESCRIPTION OF THE DRAWINGS

FIG. 1 is a cross-section of the weatherstrip according to the present invention.

FIG. 2 is cross-sections of various pads according to the present invention.

FIG. 3 is a cross-section of a modified embodiment of the weatherstrip shown in FIG. 1.

FIG. 4 is a perspective view of a convertible car to which the weatherstrip according to the present invention is mounted.

FIG. 5 is an enlarged, perspective view of the part a in FIG. 4.

FIG. 6 is a cross-section at the line 6-6 in FIG. 5.

FIG. 7 is a cross-section at the line 7-7 in FIG. 5.

### DETAILED DESCRIPTION OF THE PREFERRED EMBODIMENTS

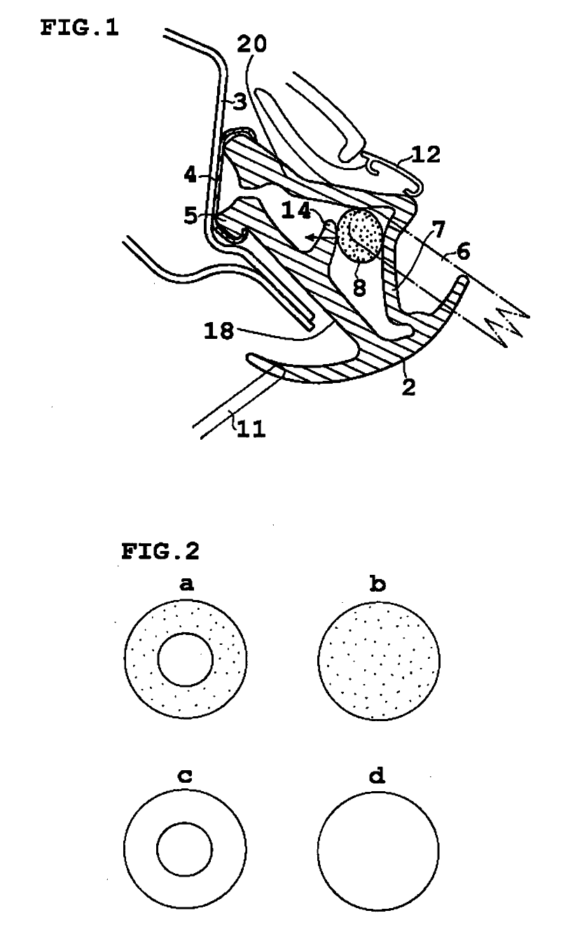

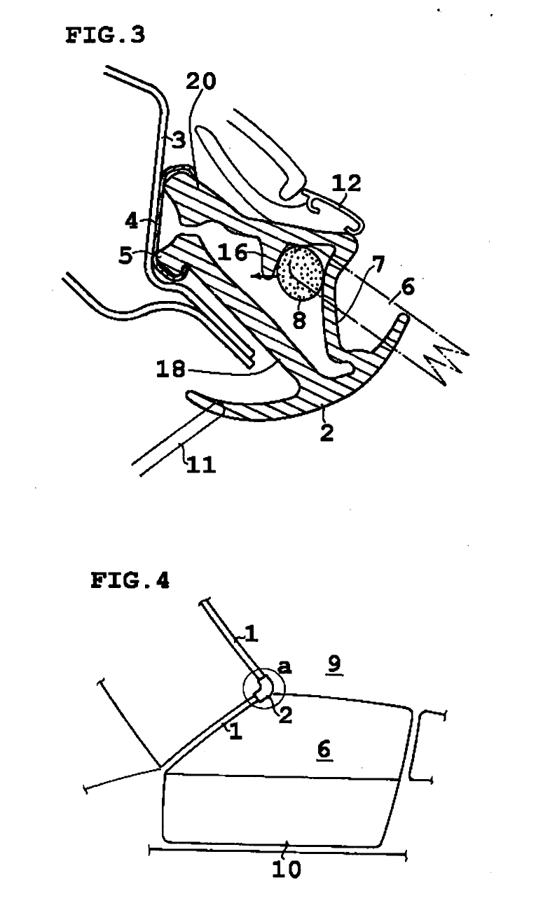

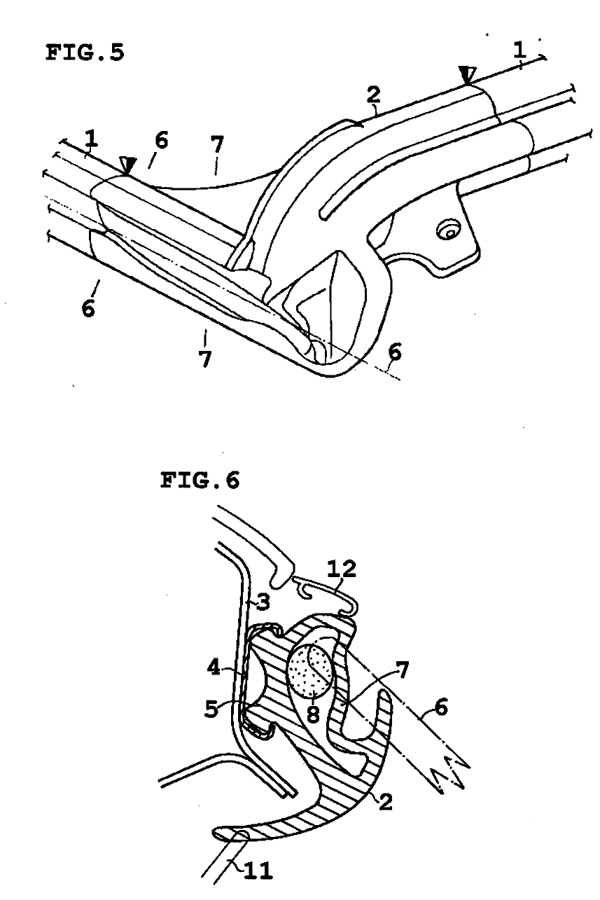

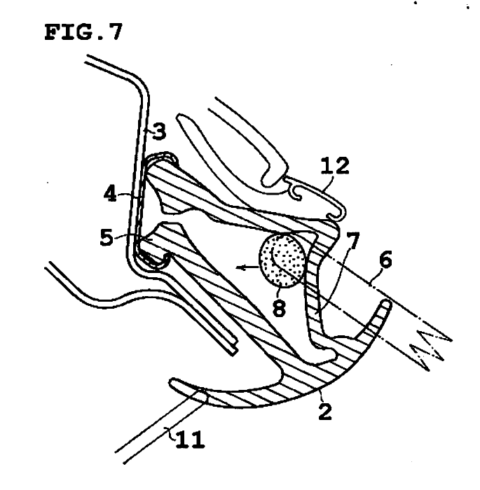

FIG. 1 is a cross-section of the weatherstrip of Embodiment 1 to show the molded part 2 at the line 6-6 in FIG. 5. FIG. 3 is a cross-section of the weatherstrip of Embodiment 2 to show the molded part 2 at the line 6-6 in FIG. 5 in a similar manner to Embodiment 1. These cross-sections correspond to FIG. 6 referred to in the description of the prior art. The same components as in FIG. 6 and FIG. 7 are given the same reference numbers and their explanation is omitted.

The differences in structure between the weatherstrip of Embodiment 1 in FIG. 1 and the prior art weatherstrip in FIG. 6 are described hereafter.

The molded part 2 is provided with a rib 14 formed on a first sidewall 18 uprising from the mounting base 5, the rib 14 protruding inside the hollow sealing section 7. The rib 14 is provided at a point where the rib 14, a second sidewall 20 also uprising from the mounting base 5, and the sealing section 7 surround and hold the pad 8. The rib 14 receives the pad 8 with its side so that the pad 8 does not move within the hollow sealing section 7 toward the mounting base 5 particularly when the side glass 6 is raised and abuts the sealing section 7. In other words, the rib 14 serves to position the pad 8 at a required point and support it. Preferably, the pad 8 is bonded to the rib 14 with adhesive such as cyanoacrylate instant adhesive and immobilized.

The pad 8 can be immobilized by adhesive only, not by the rib 14. By omitting the rib 14, the core of a mold for molding the molded part 2 shown in FIGS. 5 to 7 is not complicated and the number of steps for removing the core after molding is not increased.

The pad introduced in the sealing section can be made of foam or non-foam. Foam includes chloroprene rubber, styrene-butadiene rubber, and thermoplastic elastomer sponge. Non-foam includes solid rubber such as chloroprene rubber and EPDM.

In addition, the pad 8 can be one of those shown in FIG. 2 a to d. More specifically, they are a hollow pad made of sponge (FIG. 2a), a solid pad made of sponge (FIG. 2b), a hollow pad made of non-foam solid rubber (FIG. 2c), and a solid pad made of non-foam solid rubber (FIG. 2d). Embodiment 2 of the weatherstrip is described hereafter.

Embodiment 2 is different from Embodiment 1 in that a rib 16 protrudes from the second sidewall 20 in Embodiment 2 while the rib 14 protrudes from the first sidewall 18 in Embodiment 1. In other words, the rib 16 hangs down from the first sidewall 20. Also in this case, as in Embodiment 1, the rib 16 receives the pad 8 with its side so that the pad does not move within the hollow sealing section 7 toward the mounting base 5 when the side glass is pressed against the sealing section 7.

According to the weatherstrips of Embodiments 1 and 2 described above, the pad is positioned by the rib in a part of the hollow sealing section at a required point, whereby the weatherstrip prevent the pad from moving within the hollow sealing section 7 toward the mounting base 6 when the door is closed and the side glass 6 abuts the sealing section 7, thus the pad significantly increasing the intrinsic reaction force of the sealing section 7.

The ribs 14 and 16 are simply formed by integrally molding them with the molded part 2 that is a part of the weatherstrip. Only a little change is necessary in the mold for the prior art weatherstrip.

Bonded to the ribs 14 and 16 with adhesive, the pad 8 is more precisely positioned.

1. A weatherstrip for vehicles, comprising extruded parts and a molded part connected to said extruded parts, wherein said molded part has a hollow sealing section for elastically abutting and sealing a closure and said sealing section contains a pad in part of the hollow cross-section for improving the reaction force thereof and is provided with a positioning means for positioning said pad.

2. The weatherstrip for vehicles according to claim 1 wherein said positioning means is a rib that protrudes inside said sealing section and restricting the movement of said pad when the closure is closed.

3. The weatherstrip for vehicles according to claim 2 wherein said pad is bonded to said rib of said sealing section using adhesive.
